(19) United States
(12) Patent Application Publication
(10) Pub. No.: US 2006/0136416 A1
(43) Pub. Date: Jun. 22, 2006

(54) Apparatus and method for storing messages in a portable wireless terminal

(75) Inventor: Sung-Jun Yoo, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/265,939

(22) Filed: Nov. 3, 2005

(30) Foreign Application Priority Data
Dec. 20, 2004 (KR) 2004-108491

(51) Int. Cl. G06F 17/30

(52) U.S. Cl. 707/7

(57) ABSTRACT

Disclosed is a method for storing a message in a portable wireless terminal assigning a predetermined memory area to a plurality of message folders. The method includes checking the number of messages stored in the message folders when a new message needs to be stored; comparing the checked number of the stored messages with the maximum storable message number for the message folders predetermined according to the size of the predetermined memory area; and storing the new message in a corresponding message folder if the checked number is smaller than the predetermined maximum storable message number. The maximum storable message number for all the message folders is predetermined and the maximum storable message number for each of the message folders is flexibly managed within the limits of the maximum storable message number for all the message folders. Accordingly, an SMS storage area can be efficiently used.

### PRIORITY

This application claims priority under 35 U.S.C. § 119 to an application entitled “Apparatus And Method For Storing Messages In Portable Wireless Terminal” filed in the Korean Intellectual Property Office on Dec. 20, 2004 and assigned Serial No. 2004-108491, the contents of which are incorporated herein by reference.

### BACKGROUND OF THE INVENTION

1. Field of the Invention

The present invention relates to an apparatus and method for storing a message in a portable wireless terminal, and more particularly, to an apparatus and method for flexibly managing the number of messages stored in each message folder in a portable wireless terminal having a plurality of message folders.

2. Description of the Related Art

With the development of electronic and communication industries, the use of portable wireless terminals is becoming popular and portable wireless terminals are being developed to be compact, lightweight and have multi-functional features to satisfy the user's demands. In addition to a call function, portable wireless terminals now provide various additional functions such as phone book, game, scheduler, short message service (SMS), Internet, e-mail, morning call, and electronic calculator functions.

Among the additional functions, the SMS function is one of the most frequently used. In general, a storage area for the SMS function (hereinafter simply referred to as an SMS storage area) is divided into an incoming folder (or inbox) for storing an incoming message, an outgoing folder (or outbox) for storing an outgoing message, a draft folder (or draft box) for storing a draft message, and a user defined folder. Here, the folder represents a logical storage area and the maximum number of messages storable in each folder is predetermined. Accordingly, each folder can store only up to a predetermined number of messages. Hereinafter, the maximum number of messages storable in each folder is simply referred to as “the maximum storable message number for each folder”.

FIG. 1 is a flowchart illustrating a process for storing an incoming message in an incoming folder in the conventional portable wireless terminal.

Referring to FIG. 1, in Step 101, a controller of the terminal determines whether a message is received at the terminal. If the message is received at the terminal in Step 101, the process proceeds to Step 103, and if not, the process proceeds to Step 111. In Step 111, the controller performs other functions. In Step 103, the controller checks the number of messages currently stored in the incoming folder.

In Step 105, the controller determines whether the number of the currently-stored messages is smaller than the maximum storable message number for the incoming folder. If so, the process proceeds to Step 109, and if not, the process proceeds to Step 107. In Step 107, the controller erases the oldest message of the incoming folder. In Step 109, the controller stores the received message in the incoming folder.

The above process has been described on the assumption that an auto-erase function was set in advance in the terminal. For example, when the maximum storable message numbers respectively for the incoming, outgoing and draft folders of the SMS storage area in the terminal are all set to 100, and when a new message is received at the terminal in a state where 100 messages have been already stored in the incoming folder, the controller erases the oldest one of the 100 messages from the incoming folder and then stores the new message in the incoming folder.

That is, when a message needs to be stored in a corresponding folder, the conventional portable wireless terminal tries to store the message in the corresponding folder in consideration of only the maximum storable message number for the corresponding folder without considering the states of the other message folders. For example, when a new message is received at the terminal in a state where the incoming folder has 100 messages stored therein, the outgoing folder has 5 messages, and the draft folder has 5 messages, although the outgoing and draft folders each have an available storage area for storing 95 messages, the terminal cannot store the new message (where an auto-erase function was not set in advance therein) or erases the oldest message from the incoming folder and then stores the new message in the incoming folder (where an auto-erase function was set in advance therein).

That is, when the maximum storable message number is assigned to each of the folders, even though the non-corresponding folder has an available storage area, the mobile terminal cannot efficiently use the available storage area.

### SUMMARY OF THE INVENTION

The present invention provides an apparatus and method for efficiently managing a memory area used by each of a plurality of message folders in a portable wireless terminal.

The present invention also provides an apparatus and method for predetermining the maximum storable message number for all the message folders in a portable wireless terminal and flexibly managing the maximum storable message number for each of the message folders within the limits of the predetermined maximum storable message number for all the message folders.

According to an aspect of the present invention, a method for storing a message in a portable wireless terminal assigning a predetermined memory area to a plurality of message folders, includes checking the number of messages stored in the message folders when a new message needs to be stored; comparing the checked number of the stored messages with the maximum storable message number for the message folders predetermined according to the size of the predetermined memory area; and storing the new message in a corresponding message folder if the checked number is less than the predetermined maximum storable message number.

The method may further include erasing the oldest message of the corresponding message folder to secure an available storage area thereof unless the checked number is less than the predetermined maximum storable message number; and storing the new message in the corresponding message folder.

According to another aspect of the present invention, an apparatus for storing a message in a portable wireless terminal having a plurality of message folders, includes a memory including a predetermined memory area assigned to a plurality of message folders; and a controller for checking the number of messages currently stored in the message folders when a new message needs to be stored, comparing the checked number of the currently-stored messages with the maximum storable message number for the message folders predetermined according to the size of the predetermined memory area, and storing the new message in a corresponding message folder if the checked number is less than the predetermined maximum storable message number.

The controller may erase the oldest message of the corresponding message folder to secure an available storage area thereof unless the checked number is less than the predetermined maximum storable message number, and store the new message in the corresponding message folder.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a flowchart illustrating a process for storing an incoming message in a conventional portable wireless terminal.

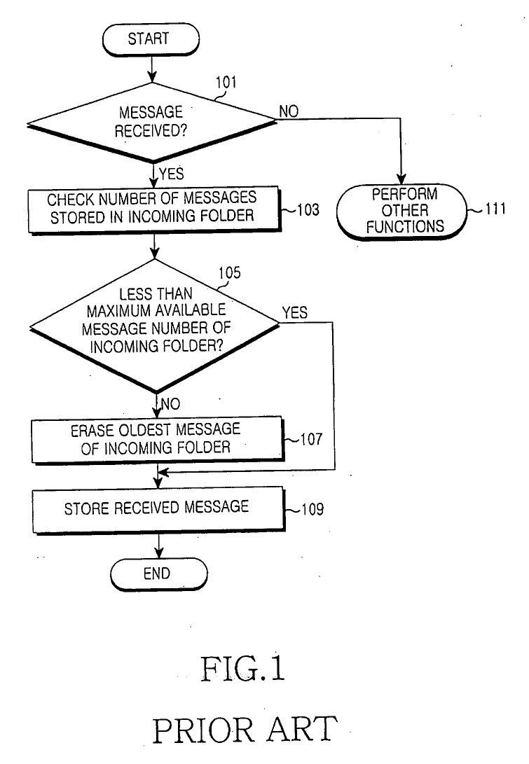

FIG. 2 is a block diagram of a portable wireless terminal according to an embodiment of the present invention;

FIG. 3 is a flowchart illustrating a procedure for storing a message in a memory in the portable wireless terminal according to an embodiment of the present invention;

FIG. 4 is a flowchart illustrating a procedure for storing a message in a memory in the portable wireless terminal according to another embodiment of the present invention; and

FIG. 5 is a diagram illustrating a method for storing a message in an actual memory area.

### DETAILED DESCRIPTION OF THE PREFERRED EMBODIMENTS

Reference will now be made in detail to the preferred embodiments of the present invention, examples of which are illustrated in the accompanying drawings. A detail description of well-known features will be omitted for conciseness.

The present invention proposes a method for flexibly managing the number of messages storable in each of a plurality of message folders in a portable wireless terminal. That is, the present invention proposes a method for flexibly managing a memory area used by each of the message folders.

Here, the message folder represents a logical storage area and may include an incoming folder (or inbox) for storing an incoming message, an outgoing folder (or outbox) for storing an outgoing message, a draft folder (or draft box) for storing a draft message, and a user defined folder for storing a specific message selected from those of other folders by users.

Also, the message may be any type of message that can be sent and received using the portable wireless terminal. For example, the message may be an SMS message, a multimedia messaging service (MMS) message, an enhanced messaging service (EMS) message, and the like.

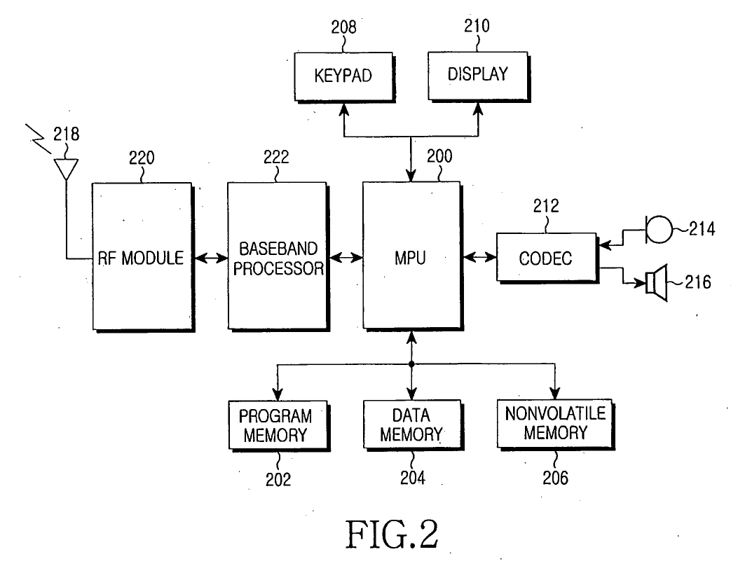

FIG. 2 is a block diagram of a portable wireless terminal according to an embodiment of the present invention. It should be noted that the portable wireless terminal includes various kinds of mobile terminals, such as a cellular phone, a Personal Communication System (PCS) phone, a Personal Data Assistant (PDA) terminal, an International Mobile Telecommunication-2000 (IMT-2000) terminal, and an Orthogonal Frequency Division Multiplexing (OFDM) terminal. A following description will be made with respect to a general structure of the terminals.

Referring to FIG. 2, a microprocessor unit (MPU) 200 controls an overall operation of the portable wireless terminal. For example, the MPU 200 processes and controls voice communication and data communication. In addition to the typical functions, the MPU 200 predetermines the maximum storable message number for all the message folders in the terminal and flexibly manages the maximum storable message number for each of the message folders within the limits of the maximum storable message number for all the message folders. A description about the typical process and control operation of the MPU 200 will be omitted for conciseness.

A memory of the terminal includes a program memory 202, a data memory 204, and a nonvolatile memory 206. The program memory 202 stores a program for controlling an overall operation of the portable wireless terminal. The program memory 202 may be a flash memory. The data memory 204 temporarily stores data that is generated during the operation of the terminal. The data memory 204 may be a random access memory (RAM). The nonvolatile memory 206 stores system parameters and other data (e.g., phone numbers). The nonvolatile memory 206 may be an electrically erasable programmable read-only memory (EEPROM). In this embodiment, a message storage area may be assigned into the nonvolatile memory 206 and a plurality of message folders shares the assigned message storage area with one another.

A keypad 208 includes numeric keys of digits 0-9 and a plurality of function keys, such as a menu key, a cancel (delete) key, a confirmation key, a talk key, an end key, an Internet connection key, and navigation keys. Key input data corresponding to a key pressed by the user is transferred to the MPU 200. A display 210 displays status information (or indicators) of the portable wireless terminal, numerals and characters, moving pictures and still pictures, and the like. A color LCD (liquid crystal display) may be used for the display 210.

A coder-decoder (CODEC) 212 connected to the MPU 200, and a speaker 216 and a microphone 214 connected to the CODEC 212 constitute an audio input/output block that is used for a phone call. The MPU 200 produces pulse code modulated (PCM) data and the CODEC 212 converts the PCM data into analog audio signals. The analog audio signals are output through the speaker 216. Also, the CODEC 212 converts audio signals received through the microphone 214 into PCM data and provides the PCM data to the MPU 200.

A radio frequency (RF) module 220 down-converts an RF signal received through an antenna 218 and provides the down-converted signal to a baseband processor 222. Also, the RF module 220 up-converts a baseband signal provided from the baseband processor 222 and transmits the up-converted signal through the antenna 118. The baseband processor 222 processes the baseband signals that are exchanged between the RF module 220 and the MPU 200. For example, in the case of CDMA data transmission, the baseband processor 222 performs channel coding and spreading on the transmission data. In the case of CDMA data reception, the baseband processor 222 performs despreading and channel decoding on the reception data.

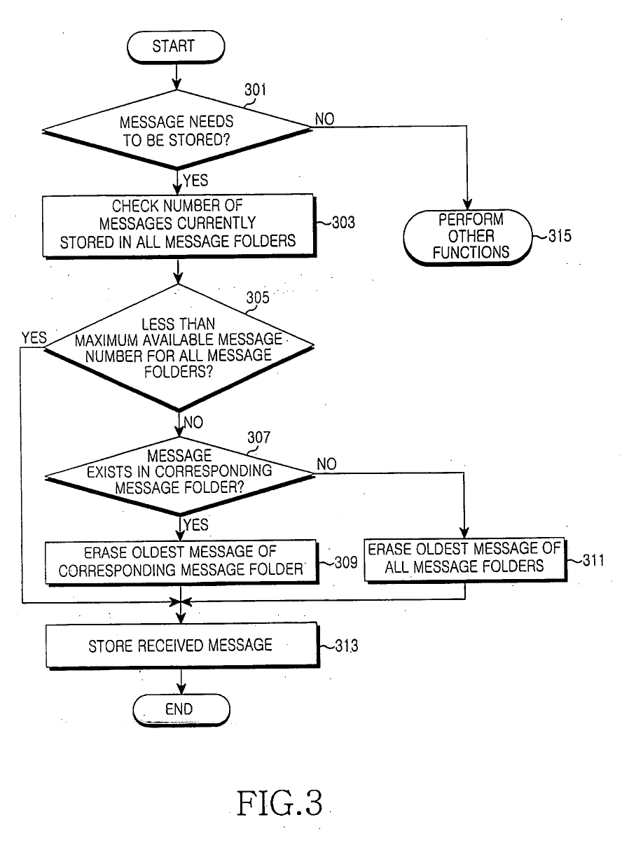

FIG. 3 is a flowchart illustrating a procedure for storing a message in a memory in the portable wireless terminal according to an embodiment of the present invention. A following description will be made on the assumption that an auto-erase function is set in advance.

Referring to FIG. 3, the MPU 200 determines in Step 301 whether a message needs to be stored. If so, the process proceeds to Step 303, and if not, the process proceeds to Step 315. Here, the message may be one of an incoming message, an outgoing message, and a draft message. A following description will be made on the assumption that the message is an incoming message.

In Step 315, the MPU 200 performs other functions. In Step 303, the MPU 200 checks the number of messages currently stored in all the message folders, that is, a predetermined memory area physically assigned to store a message.

In Step 305, the MPU 200 determines whether the checked number is less than the maximum storable message number for all the folders. If so, the process proceeds to Step 313, and if not, the process proceeds to Step 307. Here, the maximum storable message number is predetermined based on the size of the predetermined memory area. In Step 313, the MPU 200 stores the incoming message to the incoming folder. In Step 307, the MPU 200 determines whether stored messages exist in the incoming folder. If so, the process proceeds to Step 309, and if not, the process proceeds to Step 311.

In Step 309, the MPU 200 erases the oldest message of the incoming folder and thus secures an available storage area in the incoming folder. In Step 313, the MPU 200 stores the incoming message in the incoming folder. Here, the incoming message is stored at a location from which the oldest message is erased.

In Step 311, the MPU 200 erases the oldest message of all the message folders and thus secures an available storage area. In Step 313, the MPU 200 stores the incoming message in the incoming folder. Here, the incoming message is stored at a location from which the oldest message is erased.

For example, let's assume that the maximum storable message number for all the message folders is 300 and that 100 messages are currently stored in the incoming folder, 100 messages in the outgoing folder, 50 messages in the draft folder, and 50 messages in the user defined folder. In this case, when a new incoming message is generated, the MPU 200 erases the oldest message of the incoming folder and then stores the new incoming message in the incoming folder. Likewise, when a new outgoing message is generated, the MPU 200 erases the oldest message of the outgoing folder and then stores the new outgoing message in the outgoing folder. Also, when a new draft message is generated, the MPU 200 erases the oldest message of the draft folder and then stores the new draft message in the draft folder.

For another example, let's assume that the maximum storable message number for all the message folders is 300 and that no message is currently stored in the incoming folder, 100 messages in the outgoing folder, 100 messages in the draft folder, and 100 messages in the user defined folder. In this case, when a new incoming message is generated, the MPU 200 erases the oldest message of all the message folders to thereby secure an available storage area and then stores the new incoming message in the incoming folder.

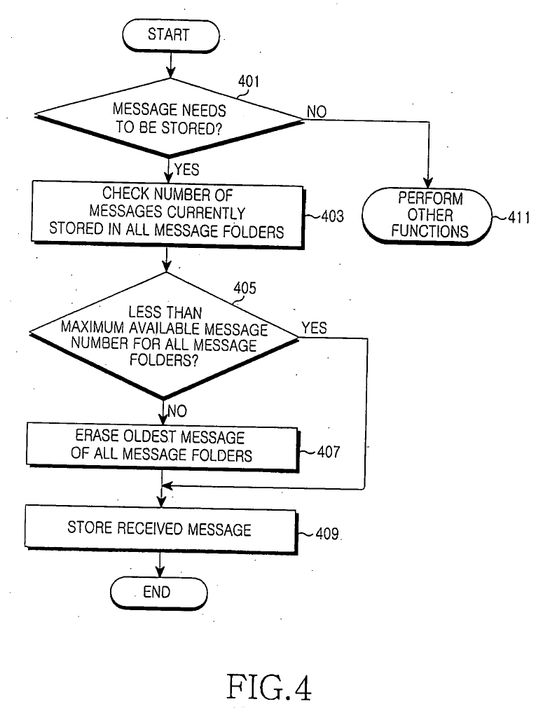

FIG. 4 is a flowchart illustrating a procedure for storing a message in a memory in the portable wireless terminal according to another embodiment of the present invention. A following description will be made on the assumption that an auto-erase function is set in advance. In this embodiment, an available storage area is secured by erasing the oldest message of all the message folders, not the oldest message of a corresponding message folder.

Referring to FIG. 4, the MPU 200 determines in Step 401 whether a message needs to be stored. If so, the process proceeds to Step 403, and if not, the process proceeds to Step 411. Here, the message may be one of an incoming message, an outgoing message, and a draft message. A following description will be made on the assumption that the message is an outgoing message.

In Step 411, the MPU 200 performs other functions. In Step 403, the MPU 200 checks the number of messages currently stored in all the message folders, that is, a predetermined memory area physically assigned to storage a message.

In Step 405, the MPU 200 determines whether the checked number is less than the maximum storable message number for all the folders. If so, the process proceeds to Step 409, and if not, the process proceeds to Step 407. Here, the maximum storable message number is predetermined based on the size of the predetermined memory area. At this time, the outgoing message may be stored at the first empty location of the predetermined memory area.

In Step 407, the MPU 200 erases the oldest message of all the message folders and thus secures an available storage area. In Step 409, the MPU 200 stores the outgoing message in the outgoing folder. Here, the outgoing message is stored at a location from which the oldest message is erased.

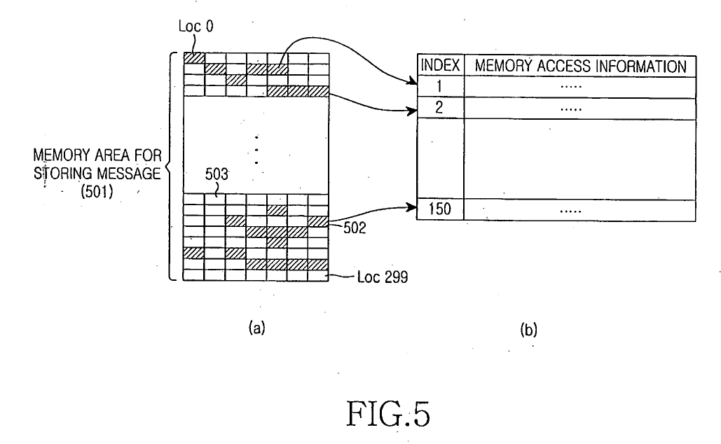

For further understanding of the present invention, an actual application example will now be described with reference to FIG. 5, which is a diagram illustrating a method for storing a message in an actual memory area.

Referring to FIG. 5, (a) illustrates a memory area 501 for storing messages. A plurality of message folders shares the memory area 501 with one another. A plurality of rectangles constitute the memory area 501, and each rectangle indicates a unit storage area. The size of the unit storage area is determined considering the maximum length of the messages, and the size of the memory area 501 is determined based on the maximum number of messages storable in all the message folders. For example, when the maximum message length is 100 bytes and the maximum storable message number is 300, the size of the memory area 501 becomes 30 K bytes. When the maximum storable message number is 300, the memory area 510 has 300 storage locations Loc 0˜Loc 299 as illustrated in FIG. 5(a). When a message needs to be stored, it is stored at an empty location of the memory area 501. In FIG. 5(a), hatched rectangles represent locations at which messages have been stored. As illustrated, messages stored in the same folder may be stored at any location of the memory area 501.

In FIG. 5, (b) illustrates a list for managing messages stored in the same folder, for example, an incoming folder. As illustrated, the list includes memory access information enabling access of an incoming message. In the present invention, since one message folder may use all of the memory area 501, the number of indexes in the list may be increased up to 300. For example, let's assume that the maximum storable message number for all the message folders is 300 and that 150 messages are currently stored in the incoming folder, 100 messages in the outgoing folder, no messages in the draft folder, and 50 messages in the user defined folder. In this case, when a new incoming message is generated, the MPU 200 erases the oldest message of the incoming folder and then stores the new incoming message at a location 502 from which the oldest message is erased. When a new draft message is generated, since no messages exist in the draft folder, the MPU 200 erases the oldest message of the memory area 501 and then stores the new draft message at a location 503 from which the oldest message is erased. In this manner, the present invention makes it possible to enable one message folder to use all of the memory area 501, and to flexibly secure an available storage area for a new message by erasing a message of another message folder when a message folder corresponding to the new message has no available storage area.

In modifications of the present invention, priority for the auto-erase function may be given to each message folder. That is, a message folder from which a message is to be automatically erased may be determined according to the given priority, and a message folder having the highest priority may be prevented from experiencing the auto-erase operation. Also, the priority may be determined by the user.

As described above, the present invention predetermines the maximum storable message number for all the message folders, not for each message folder, and flexibly manages the maximum storable message number for each of the message folders within the limits of the predetermined maximum storable message number for all the message folders, thereby making it possible to improve the efficiency of the SMS storage area. Accordingly, the SMS storage area can be fully used without waste.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method for storing a message in a portable wireless terminal assigning a predetermined memory area to a plurality of message folders, the method comprising the steps of:
determining the number of messages stored in the message folders when a new message needs to be stored;
comparing the determined number of the stored messages with a predetermined maximum storable message number for the message folders according to the size of the predetermined memory area; and
storing the new message in a corresponding message folder if the determined number is less than the predetermined maximum storable message number.

2. The method of claim 1, wherein the message folders include an incoming folder, an outgoing folder, a draft folder, and a user defined folder.

3. The method of claim 1, wherein the new message is one of an incoming message, an outgoing message, and a draft message.

4. The method of claim 1, further comprising the steps of:
erasing an oldest message of the corresponding message folder to secure an available storage area thereof unless the determined number is less than the predetermined maximum storable message number; and
storing the new message in the corresponding message folder.

5. The method of claim 4, wherein the new message is stored at a location from which the oldest message is erased.

6. The method of claim 1, further comprising the steps of:
erasing an oldest message of the message folders to secure an available storage area unless the determined number is less than the predetermined maximum storable message number; and
storing the new message in the corresponding message folder.

7. The method of claim 6, wherein the new message is stored at a location from which the oldest message is erased.

8. The method of claim 4, further comprising the steps of:
determining whether a message exists in the corresponding message folder unless the determined number is less than the predetermined maximum storable message number;
erasing the oldest message of the corresponding message folder and then storing the new message in the corresponding message folder if a message exists in the corresponding message folder; and
erasing the oldest message of the message folders and storing the new message in the corresponding message folder if no message exists in the corresponding message folder.

9. An apparatus for storing a message in a portable wireless terminal having a plurality of message folders, the apparatus comprising:
a memory including a predetermined memory area assigned to a plurality of message folders; and
a controller for determining the number of messages currently stored in the message folders when a new message needs to be stored, comparing the determined number of the currently-stored messages with a predetermined maximum storable message number for the message folders according to the size of the predetermined memory area, and storing the new message in a corresponding message folder if the determined number is less than the predetermined maximum storable message number.

10. The apparatus of claim 9, wherein the message folders include an incoming folder, an outgoing folder, a draft folder, and a user defined folder.

11. The apparatus of claim 9, wherein the new message is one of an incoming message, an outgoing message, and a draft message.

12. The apparatus of claim 9, wherein the controller erases an oldest message of the corresponding message folder to secure an available storage area thereof unless the determined number is less than the predetermined maximum storable message number, and stores the new message in the corresponding message folder.

13. The apparatus of claim 9, wherein the new message is stored at a location from which the oldest message is erased.

14. The apparatus of claim 9, wherein the controller erases an oldest message of the message folders to secure an available storage area unless the determined number is less than the predetermined maximum storable message number, and stores the new message in the corresponding message folder.

15. The apparatus of claim 14, wherein the new message is stored at a location from which the oldest message is erased.
